(19) United States
(12) Patent Application Publication
(10) Pub. No.: US 2007/0221255 A1
(43) Pub. Date: Sep. 27, 2007

(54) METHOD FOR CLEANING INDUSTRIAL EQUIPMENT EXPOSED TO VOLATILE ORGANIC COMPOUNDS

(76) Inventor: Adelbert D. Burdge, Houston, TX (US)

Correspondence Address: BROUSE MCDOWELL LPA, 388 SOUTH MAIN STREET, SUITE 500, AKRON, OH, 44311, US

(21) Appl. No.: 11/689,911

(22) Filed: Mar. 22, 2007

Related U.S. Application Data
(60) Provisional application No. 60/784,691, filed on Mar. 22, 2006.

(51) Int. Cl. B08B 3/00

(52) U.S. Cl. 134/26

(57) ABSTRACT

The present invention relates to a method for cleaning industrial vessels that are exposed to volatile organic compounds. The method has the steps of providing industrial equipment to be cleaned that has accumulated volatile organic compounds. Next, an organic cleaning solution is provided. The cleaning solution is transformed into foam. The foam is applied to a media of said equipment, such as a ceramic bed. The lower bubbles of the foam burst as the bubbles contact the media such that said cleaning solution continuously reapplies itself to the media of said equipment. During the process, operators ensure the cleaning solution stays in a wet phase. The equipment undergoes numerous rinsing phases and then the media is dried.

This application claims priority to a provisional application filed on Mar. 22, 2006, having Ser. No. 60/784,691.

### I. BACKGROUND OF THE INVENTION

A. Field of Invention

The present invention is a method for cleaning industrial equipment that is exposed to volatile organic compounds.

B. Description of the Related Art

Volatile organic compounds (VOCs) are emitted as gasses from certain solids or liquids. VOCs come from a wide array of chemical products. Some examples include paints and lacquers, glues, adhesives, paint strippers, cleaning supplies, pesticides, building materials, and even fuels. The Environmental Protection Agency and State Air Quality Boards are continuously concerned of VOCs since VOCs have been found to be a contributing factor to ozone air pollutants.

In the industrial setting, various units are used to capture, concentrate and destroy VOCs at plant locations. These units include radiant/regenerative thermal oxidizers (RTOs), radiant/regenerative catalytic oxidizers (RCOs), selective catalytic converters (SCRs), and wet electrostatic precipitators (Wet ESP).

Generally, vapors from process equipment are captured by hoods and/or duct work at a plant. The vapors are directed to mixing chambers to be mixed with a precipitating liquid. The mixture passes between electrically charged plates and wires. A majority of the mixture adheres to the plates by static cling. The remaining gases are directed to vessels containing beds of either ceramic or ceramic with imbedded catalyst. The beds are fired by natural gas. The ceramic packing in the beds creates a heat sink, where the destruction of VOCs is accomplished. The RTO unit works by simple heat/dwell time process that allows more complete combustion of the waste. The normal operating temperature must remain above 1358° F. plus or minus for complete combustion. The operating permit will always specify a minimum temperature for compliance.

The RCO unit uses regular ceramic packing for support of a layer of similar ceramic that is coated or impregnated with a catalyst formula. The RCO operates at around 600-850° F. The RCO is also gas fired. If it is operated as designed, the VOCs and the plant waste will sustain the heat after the system is brought up to operating temperature.

The problem with both types of units occurs when the material to be burnt begins to collect in and on the ceramics. This build up can eventually completely “blind” the beds. This build up may be due to several different factors such as: (1) residue being allowed to accumulate in the duct work, which leads to restricted gas flow with an increase in flow velocity; (2) increased velocity allows excess material to be carried through the ESPs; and (3) the increase in material exceeds the design parameters of the combustion chambers. Build up of VOC's has the following effects: (1) it exceeds the permeable emissions; (2) more natural gas is required to meet temperature requirements; (3) increased fan loading to overcome the Delta P; (4) damage to the ceramics or catalysts; (5) damage to the unit structure from improper heat transfer; and (6) reduction of plant capacity due to the inability to process waste gases. In turn, plants increase costs because of these effects. These plants incur air pollution fines, premature failure of fans in unit structures, decrease life of ceramics, increase energy costs for natural gas, and production loss due to unplanned forced outages to clean or repair unit. What is needed is a regular scheduled cleaning of all hoods and duct work including fans, wet ESPs and ceramics and catalysts. The present invention provides an inventive method utilizing a special detergent to maximize production of product at the minimum outlay of cost minimum investment.

### II. SUMMARY OF THE INVENTION

An inventive method for the cleaning of thermal oxidizer media including the steps of arriving on site; preparing the various equipment that needs cleaned; preparing the chemical solutions for cleaning; applying the chemical solution; rinsing the chemical solutions; and having the vessel cleaned.

The inventive method may also comprise the steps of providing industrial equipment to be cleaned that has accumulated volatile organic compounds; providing an organic cleaning solution; transforming said cleaning solution into foam; applying said foam to a media of said equipment; bursting lower bubbles as said bubbles contact said media such that said cleaning solution continuously reapplies itself to said media of said equipment; ensuring said cleaning solution stays in a wet phase; rinsing said media; and drying said media.

Another aspect of the present invention is to provide a method to clean industrial equipment, wherein the media may have a temperature that is no higher than 180° F. before the foam is applied thereto.

Another aspect of the present invention is to provide a method to clean industrial equipment, wherein the step of rinsing the media may further comprise the step of rinsing the media with potable water, the potable water having a first pH level, the first pH level being a first baseline reading.

Another aspect of the present invention is to provide a method to clean industrial equipment, wherein the step of rinsing the media with potable water may further comprise the step of rinsing the media at a predetermined flow rate until the potable water is clear of visible fouling.

Another aspect of the present invention is to provide a method to clean industrial equipment, which may further comprise the step of continuing rinsing the media until the potable water reaches a pH level of at least 5.

Another aspect of the present invention is to provide a method to clean industrial equipment, which may further comprise the steps of performing a final rinsing stage with the potable water, the potable water having a second pH level; and continuing rinsing the media until the second pH level of the potable water is within 1.0 or less of the first pH level of the potable water.

Another aspect of the present invention is to provide a method to clean industrial equipment, wherein the step of applying the foam to a media of the industrial equipment may further comprise the step of removing the industrial equipment from its operating location in an associated facility before applying at least two inches of foam to the media of the industrial equipment.

Another aspect of the present invention is to provide a method to clean industrial equipment, wherein the step of applying the foam to a media of the industrial equipment may further comprise the step of maintaining the industrial equipment in its operating location in an associated facility before applying at least two inches of foam to the media of the industrial equipment.

Another aspect of the present invention is to provide a method to clean industrial equipment, wherein the cleaning solution may be ICS-CC-2006.

Another aspect of the present invention is to provide a method to clean industrial equipment, wherein the step of applying the foam may further comprise the step of applying at least two inches of foam to the media.

Another aspect of the present invention is to provide a method to clean industrial equipment, wherein the media has fouling, wherein the step of applying the foam may further comprise the step of determining an amount of foam to be applied based upon the amount of fouling.

Another aspect of the present invention is to provide a method to clean industrial equipment, wherein if the foam becomes saturated with fouling, the method may further comprise the steps of rinsing the saturated fouling; and, reapplying the foam to the media.

Another aspect of the present invention is to provide a method to clean industrial equipment, wherein the foam remains on the media for at least two hours.

Another aspect of the present invention is to provide a method to clean industrial equipment, wherein the equipment may be a radiant/regenerative thermal oxidizer, radiant/regenerative catalytic oxidizers, a selective catalytic converter, or a wet electrostatic precipitator.

Another aspect of the present invention is to provide a method to clean industrial equipment, wherein the media may be a ceramic saddle, a blocks plain with catalyst coating, or metal.

It is an object of the present invention to provide a basic industrial equipment cleaning procedure which is cost effective.

It is another object of the present invention to provide a basic industrial equipment cleaning procedure that is able to be performed by in-house employees.

It is another object of the present invention to provide a basic industrial equipment cleaning procedure that eliminates down time at a plant, thereby increasing the production of that plant.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of a plant where the inventive method can be carried out.

FIG. 2 is a photograph of industrial cleaning equipment with fouling that requires cleaning.

FIG. 3 is a photograph showing the applied cleaning solution.

FIG. 4 is a photograph of ceramics that have been through bake out procedures known in the art and not maintained clean.

FIG. 5 is a photograph of ceramics that have undergone the inventive method for cleaning and maintenance.

### IV. DESCRIPTION OF THE PREFERRED EMBODIMENT

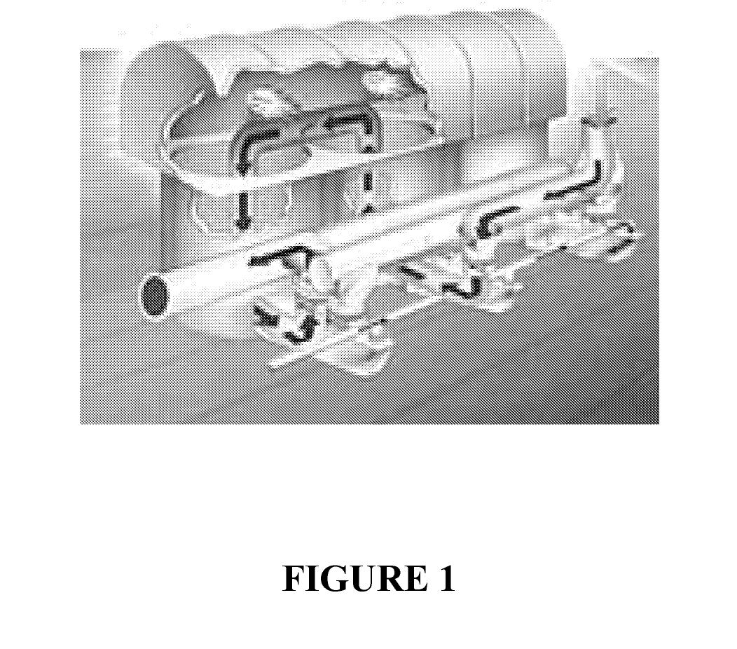

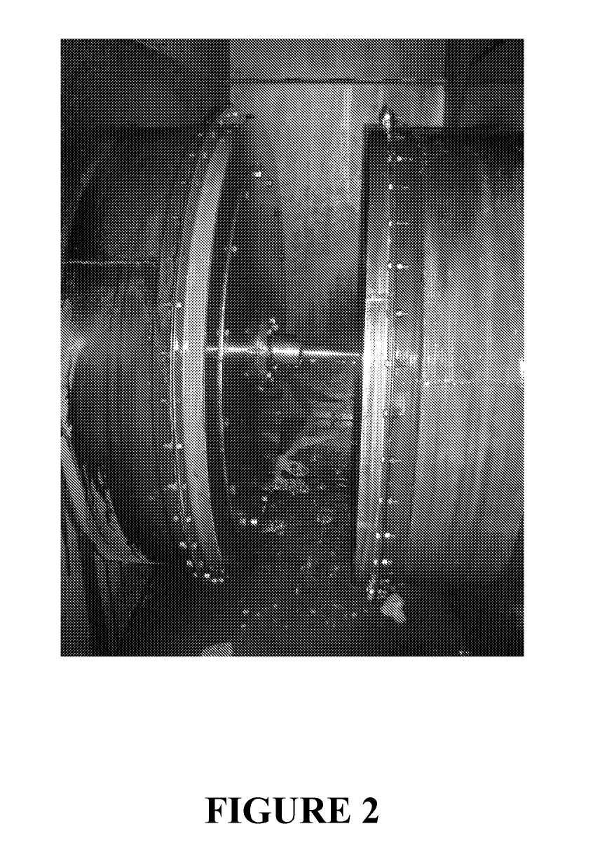

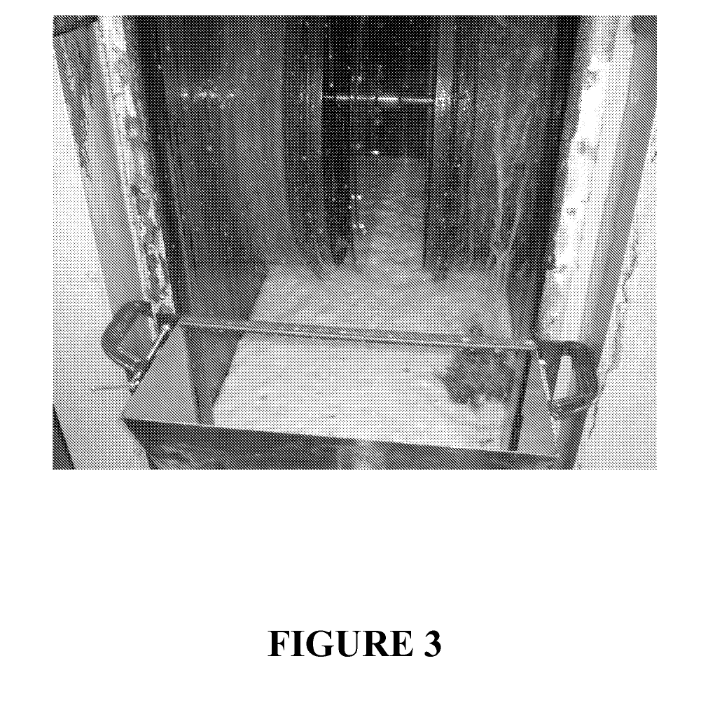

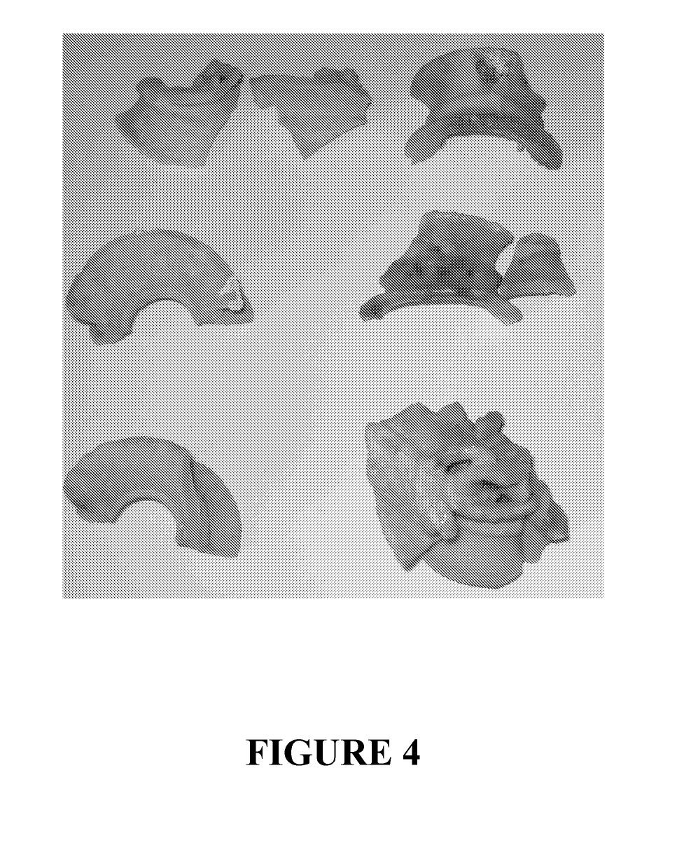

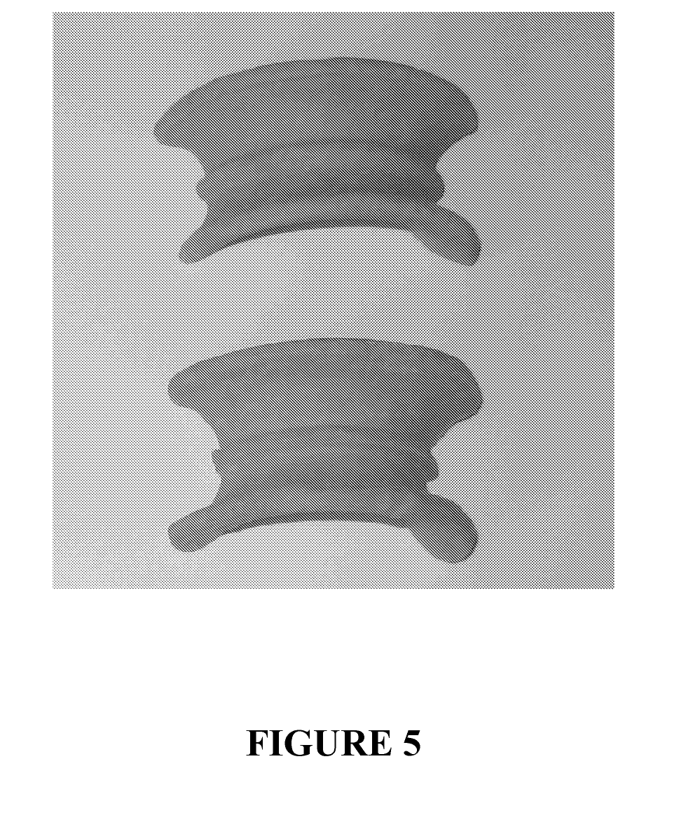

Referring now to the drawings wherein the showings are for purposes of illustrating a preferred embodiment of the invention only and not for purposes of limiting the same, FIGS. 1-5 illustrate various aspects of the present invention.

The present invention is a basic RCO/RTO cleaning procedure. The process can be used in the wood product and automotive coatings industry. It can also be used to clean units treating the vapors generated by plywood production, OSB presses and driers and solvents from painting automobiles and equipment.

In most instances, the media is returned to within 5% to 10% of “as new” VOC destruction. The useful life of the media can be extended by up to ten times when compared with traditional burnouts and water washing.

To determine the amount of time required the following factors are considered: the amount and type of normal contamination, the current destruction levels, the type of unit, type and brand of media, on site waste handling capacity and available time.

The scheduled cleaning of the system will maintain the equipment in the peak of operating conditions. A well maintained system is much more efficient and requires less natural gas to maintain the design temperature. By scheduling regular cleaning, the risk of a forced outage due to loss of destructive action of the media is minimized. This alone saves many times the cost of the cleaning process, due to lost production and or fines due to regulatory non-compliance. The regular cleaning also saves the cost replacing the media and the disposal of the existing media.

The inventive process involves the application of a liquid cleaning solution to media beds of the industrial equipment. As previously stated, industrial equipment may include, but is not limited to a radiant/regenerative thermal oxidizer, radiant/regenerative catalytic oxidizers, a selective catalytic converter, or a wet electrostatic precipitator. Further, the media beds may be ceramic saddle, a blocks plain with catalyst coating, or metal. The blocks are monolithic blocks and may take the place of the saddles for flow design and manufacturer's preference.

Generally, an organic, biodegradable cleaning solution is applied to fouling existing on the industrial equipment. One such example of the liquid solution is ICS-CC-2006™, which is commercially available from Innovative Cleaning Solutions, whose principle place of business is 1004-96^{th} Street, Houston, Tex. 77012. This application is repeated to reach the desired level of contaminant removal. The fouling is then rinsed, with water, until the residues are thoroughly flushed from the media. All wastes are collected and either pumped to in-house waste treatment or transport containers for removal to off-site disposal.

In order for the inventive procedure to be utilized, certain plant requirements are needed. The plant needs to have the media temperature at or below about 250° F. However, it can be as low as 180° F. or as low as 40° F. before turning over the equipment for the commencement of a cleaning procedure. The media could be destroyed because of the thermal shock, and thus become unusable, if the cleaning solution is introduced to the media if it is above 180° F. Mechanical procedures at the plant need to be performed before cleaning, which may include, but is not limited to the removal of man ways, flanges and disposal issues. Next, the plant is evaluated by a representative to discuss the equipment staging and the waste stream containment. Lockout/tag-out procedures are performed and all required permits issued.

The necessary equipment is positioned at the designated work area so as not to interfere with the daily plant operations. The chemical cleaning solutions are blended for dilution rates for the proper ratio as per the plants fouling conditions. Air driven diaphragm pumps may inject air into a discharge side of a pump (not shown) so that the cleaning solution is turned into foam. As such, the cleaning solution may take liquid or foam form; however, it is more economical to use the foam form. The chemical solution is applied to the media of the unit. The chemical solution is applied as wet foam about two inches thick on top of the media beds. The thickness of the foam is dictated by the amount of fouling present. A great amount of fouling requires a great amount of foam. Because the cleaning solution takes the form of foam, the cleaning solution is constantly reapplying itself to the media as the bottom bubbles burst. As those bubbles burst, they create a mechanical scrubbing action as the foam dissipates. The foam is left in place for at least one hour and as long as five hours. In another embodiment of the present invention, the foam is left on the equipment between two and four hours. The chemical solution is then applied to a chamber face of a catalyst. The cleaning solution is monitored to ensure that it does not dry on the media and stays in the required wet phase.

Continuing with the inventive process, the media is rinsed with potable water. The potable water has a first pH level, and the first pH level serves as a first baseline reading. The media is flushed with potable water at the predetermined flow rate until it is determine that the effluent is clear of visible fouling. The flushing procedure continues until the pH reaches at least 5.0 or greater. During the flushing time, the user will be pumping the residue to the plant's designated contaminate area.

After the chemical solutions been titrated and spent, the final flushing procedure begins with plant supplied potable water. During this flushing phase, the used potable water has a second pH level. The media is continued to be rinsed until the second pH level of the potable water reaches within 1.0 or less of the inlet potable water pH that has the first pH level.

In another embodiment of the present invention, the amount of fouling present in the industrial equipment may be significant. In this instance, after the foam is applied to the fouling, it may become saturated with fouling. If this occurs, the foam is rinsed with potable water and the foam is reapplied to the media. This continues until the foam is able to remain on the media without become completely saturated with fouling. It is preferred that the fouling to precipitate out of the foam during the cleaning stage.

Next, the operators begin pumping out the residue from the system. This may include rinsing of lower chambers and plenums. The operators then remove the equipment utilized during the cleaning procedure for the turnover of the cleaned industrial equipment to the plant operations drying phase. The plants drying phase should be extended from the normal warm up procedure by 30%.

It will also be appreciated that the inventive method may be applied to equipment that remains in its operating location in the plant facility before it is cleaned. Alternatively, the industrial equipment and/or media may be removed and taken to a remote location for cleaning. In this instance, the media may be placed in a vat or other containment member for the cleaning process.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

What is claimed is:

1. A method for cleaning a radiant/regenerative thermal oxidizer (RTO)/radiant/regenerative catalytic oxidizer (RCO), comprising the steps of:
providing an RCO and/or RTO to be cleaned;
providing an organic cleaning solution;
transforming said cleaning solution into foam;
applying said foam to a media of said RCO and/or RTO;
bursting lower bubbles as said bubbles come into contact with said media such that said cleaning solution continuously reapplies itself to said media of said RCO and/or RTO;
ensuring said cleaning solution stays in a wet phase;
rinsing said media; and
drying said media.

2. The method of claim 1, wherein said media has a temperature that is no higher than 180° F. before said foam is applied thereto.

3. The method of claim 1, wherein the step of rinsing said media further comprises the step of:
rinsing said media with potable water, said potable water having a first pH level, said first pH level being a first baseline reading.

4. The method of claim 3, wherein the step of rinsing said media with potable water further comprises the step of:
rinsing said media at a predetermined flow rate until said potable water is clear of visible fouling.

5. The method of claim 4, further comprising the step of:
continuing rinsing said media until said potable water reaches a pH level of at least 5.

6. The method of claim 4, further comprising the step of:
performing a final rinsing stage with said potable water, said potable water having a second pH level;
continuing rinsing said media until said second pH level of said potable water is within 1.0 or less of said first pH level of said potable water.

7. The method of claim 1, wherein said media is a ceramic bed.

8. The method of claim 1, wherein the step of applying said foam to a media of said RCO and/or RTO further comprises the step of:
removing said RCO and/or RTO from its operating location in an associated facility before applying at least two inches of foam to said media of said RCO and/or RTO.

9. The method of claim 1, wherein the step of applying said foam to a media of said RCO and/or RTO further comprises the step of:
maintaining said RCO and/or RTO in its operating location in an associated facility before applying at least two inches of foam to said media of said RCO and/or RTO.

10. The method of claim 1, wherein said cleaning solution is ICS-CC-2006.

11. The method of claim 1, wherein said step of applying said foam further comprises the step of:
applying at least two inches of foam.

12. The method of claim 1, wherein said media has fouling, wherein said step of applying said foam further comprises the step of:
determining an amount of foam to be applied based upon the amount of fouling.

13. The method of claim 12, wherein if said foam becomes saturated with fouling, the method further comprises the steps of:
rinsing said saturated fouling; and,
reapplying said foam to said media.

14. The method of claim 1, wherein said foam remains on said media for at least two hours.

15. A method for cleaning industrial equipment, comprising the steps of:
providing industrial equipment to be cleaned that has accumulated volatile organic compounds;
providing an organic cleaning solution;
transforming said cleaning solution into foam;
applying said foam to a media of said equipment;
bursting lower bubbles as said bubbles contact said media such that said cleaning solution continuously reapplies itself to said media of said equipment;
ensuring said cleaning solution stays in a wet phase;
rinsing said media; and
drying said media.

16. The method of claim 15, wherein said equipment is a radiant/regenerative thermal oxidizer, radiant/regenerative catalytic oxidizers, a selective catalytic converter, or a wet electrostatic precipitator.

17. The method of claim 15, wherein said media is a ceramic saddle, a blocks plain with catalyst coating, or metal.

18. The method of claim 15, wherein the step of rinsing said media further comprises the step of:
rinsing said media with potable water, said potable water having a first pH level.
continue rinsing said media at a predetermined flow rate until said potable water is clear of visible fouling and reaches a pH level of at least 5;
performing a final rinsing stage with said potable water, said potable water having a second pH level;
continuing rinsing said media until said second pH level of said potable water is within 1.0 or less of said first pH level of said potable water.

19. The method of claim 15, wherein the step of applying said foam to a media of said equipment comprises applying two inches of said foam to said media; and
wherein, said method further comprises the step of:
rinsing said media after said foam remains on said equipment for between about 2 to about 4 hours.

20. A method for cleaning industrial equipment, comprising the steps of:
providing industrial equipment to be cleaned that has accumulated volatile organic compounds;
providing an organic, biodegradable cleaning solution;
transforming said cleaning solution into foam;
applying said foam to a media of said equipment;
bursting lower bubbles such that said cleaning solution continuously reapplies itself to said media of said equipment;
ensuring said cleaning solution stays in a wet phase;
rinsing said media with potable water, said potable water having a first pH level.
continue rinsing said media at a predetermined flow rate until said potable water is clear of visible fouling and reaches a pH level of at least 5;
performing a final rinsing stage with said potable water, said potable water having a second pH level;
continuing rinsing said media until said second pH level of said potable water is within 1.0 or less of said first pH level of said potable water; and
drying said media, wherein said equipment is a radiant/regenerative thermal oxidizer, radiant/regenerative catalytic oxidizers, a selective catalytic converter, or a wet electrostatic precipitator.
